(19) United States
(12) Patent Application Publication
(10) Pub. No.: US 2024/0064787 A1
(43) Pub. Date: Feb. 22, 2024

(54) METHOD FOR INFORMATION PROCESSING, COMMUNICATION DEVICE, AND NON-TRANSITORY COMPUTER STORAGE MEDIUM

(71) Applicant: BEIJING XIAOMI MOBILE SOFTWARE CO., LTD., Beijing (CN)

(72) Inventor: Shengxiang GUO, Beijing (CN)

(73) Assignee: BEIJING XIAOMI MOBILE SOFTWARE CO., LTD., Beijing (CN)

(21) Appl. No.: 18/260,746

(22) PCT Filed: Jan. 8, 2021
(86) PCT No.: PCT/CN2021/070860

§ 371 Date: Jul. 7, 2023

(51) Int. Cl. H04W 72/51; H04W 72/0446; H04W 56/00

(52) U.S. Cl. CPC H04W 72/51; H04W 72/0446; H04W 56/00; H04W 92/18

(57) ABSTRACT

A method for information processing that can include determining, by a base station, according to a synchronous transmission capability of a terminal for a first wireless transmission mode and a second wireless transmission mode, a resource alignment mode in a time domain for a first wireless resource and a second wireless resource configured for the terminal.

### CROSS REFERENCE

The present application is a U.S. National Stage of International Application No. PCT/CN2021/070860, filed on Jan. 8, 2021, all contents of which are incorporated herein by reference in their entireties for all purposes.

### BACKGROUND

### Technical Field

The present disclosure relates to the technical field of wireless communications, but is not limited to the technical field of wireless communications, and in particular, to a method and an apparatus for information processing, a communication device, and a storage medium.

### Description of the Related Art

The wireless communication technology of Vehicle to Everything (V2X) is a new generation of information communication technology for connecting the vehicle to everything. V2X may provide two communication interfaces, referred to as a cellular communication interface (Uu interface) and a direct communication interface (PC5 interface), respectively.

### SUMMARY

According to embodiments of a first aspect of the present disclosure, there is provided a method for information processing, applied to a base station. The method includes determining, by a base station, according to a synchronous transmission capability of a terminal for a first wireless transmission mode and a second wireless transmission mode, a resource alignment mode in a time domain for a first wireless resource and a second wireless resource configured for the terminal.

According to embodiments of a second aspect of the present disclosure, there is provided a method for information processing. The method includes obtaining, by a terminal, configuration information of a resource alignment mode, where the configuration information is determined according to a synchronous transmission capability of the terminal for a first wireless transmission mode and a second wireless transmission mode, and indicates a resource alignment mode in a time domain for a first wireless resource and a second wireless resource of the terminal.

According to embodiments of a third aspect of the present disclosure, there is provided a communication device, including a processor, a transceiver, a memory, and an executable program stored on the memory and capable of being run by the processor, where the processor executes the method for information processing provided in the first aspect or the second aspect when running the executable program.

According to embodiments of a fourth aspect of the present disclosure, there is provided a non-transitory computer storage medium, and the computer storage medium stores an executable program; after the executable program is executed by the processor, the method for information processing provided in the first aspect or the second aspect is able to be implemented.

It should be understood that the general description above and the detailed description in the following text are only illustrative and explanatory, and do not limit the embodiments of the present disclosure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic structural diagram of a wireless communication system according to some embodiments of the present disclosure;

FIG. 2 is a schematic flowchart of a method for information processing according to some embodiments of the present disclosure;

FIG. 3A is a schematic diagram of alignment of a time axis according to some embodiments of the present disclosure;

FIG. 3B is a schematic diagram of alignment of a time axis according to some embodiments of the present disclosure;

FIG. 4A is a schematic flowchart of a method for information processing according to some embodiments of the present disclosure;

FIG. 4B is a schematic flowchart of a method for information processing according to some embodiments of the present disclosure;

FIG. 4C is a schematic flowchart of a method for information processing according to some embodiments of the present disclosure;

FIG. 5 is a schematic flowchart of a method for information processing according to some embodiments of the present disclosure;

FIG. 6 is a schematic structural diagram of an apparatus for information processing according to some embodiments of the present disclosure:

FIG. 7 is a schematic structural diagram of an apparatus for information processing according to some embodiments of the present disclosure;

FIG. 8 is a schematic flowchart of a method for information processing according to some embodiments of the present disclosure:

FIG. 9 is a schematic structural diagram of a terminal (also referred to as a UE) according to some embodiments of the present disclosure; and

FIG. 10 is a schematic structural diagram of a base station according to some embodiments of the present disclosure.

### DETAILED DESCRIPTION OF THE PREFERRED EMBODIMENTS

Referring now to the drawings, wherein like reference numerals designate identical or corresponding parts throughout the several views.

Example embodiments will be explained in detail here, which is illustrated in the accompanying drawings. When the following description refers to the accompanying drawings, unless otherwise indicated, the same numbers in different drawings represent the same or similar elements. The embodiments described in the following example embodiments do not represent all embodiments that are consistent with the embodiments of the present disclosure. On the contrary, they are only examples of apparatuses and methods that are consistent with some aspects of the embodiments of the present disclosure as detailed in the attached claims.

The terms used in the embodiments of the present disclosure are only for a purpose of describing specific embodiments, and are not intended to limit the embodiments of the present disclosure. The singular forms of “one”, “a” and “the” used in the embodiments of the present disclosure and the attached claims are also intended to include the majority form, unless the context clearly indicates other meanings. It should also be understood that the term “and/or” used in the context refers to and includes any or all possible combinations of one or more related listed items.

It should be understood that although the terms first, second, third, may be used to describe various information in the embodiments of the present disclosure, such information should not be limited to these terms. These terms are only used to distinguish the same type of information from each other. For example, without departing from the scope of the embodiments of the present disclosure, the first information can also be referred to as the second information, and similarly, the second information can also be referred to as the first information. Depending on the context, the word “if” used here can be interpreted as “at . . . time” or “when” or “in response to determining”.

The requirement of spectrum based on operators is increasing day by day, however, the actual spectrum that can be allocated for use gradually decreases. For an existing authorized frequency band of an operator, it is currently a major requirement for the operator to transmit new radio (NR) V2X services simultaneously on the frequency band. For simultaneously using NR V2X transmission sidelink (SL) services on the same authorized frequency band, it is needed to consider the synchronization requirements of the NR authorized spectrum service and the NR SL service.

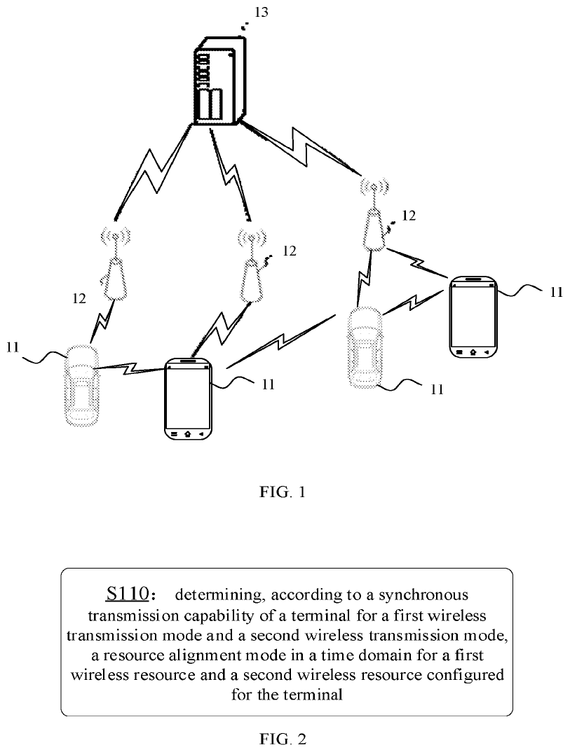

With reference to FIG. 1, it shows a schematic structural diagram of a wireless communication system according to some embodiments of the present disclosure. As shown in FIG. 1, the wireless communication system is a communication system based on a cellular mobile communication technology, and the wireless communication system may include several UEs 11 and several base stations 12.

Among them, the UE 11 may refer to a device that provides voice and/or data connectivity to a user. The UE 11 may communicate with one or more core networks via a radio access network (RAN). The UE 11 may be an Internet of Things UE, such as a sensor device, a mobile phone (or referred to as a “cellular” phone), and a computer having an Internet of Things UE. For example, it may be a fixed, portable, pocket, handheld, computer built-in or vehicle-mounted apparatus, such as a station (STA), a subscriber unit, a subscriber station, a mobile station, a mobile station, a remote station, an access point, a remote terminal, an access terminal, a user terminal, a user agent, a user device, or user equipment (UE). Alternatively, the UE 11 may also be a device of the unmanned aerial vehicle. Alternatively, the UE 11 may also be a vehicle-mounted device, for example, it may be a trip computer having a wireless communication function, or a wireless communication device externally connected to a trip computer. Alternatively, the UE 11 may also be an infrastructure, for example, it may be a street lamp, a signal light or another infrastructure having a wireless communication function.

The base station 12 may be a network-side device in a wireless communication system. The wireless communication system may be a 4th generation mobile communication (4G) system, also referred to as a long term evolution (LTE) system. Alternatively, the wireless communication system may be a 5G system, also referred to as a new radio (NR) system or a 5G NR system. Alternatively, the wireless communication system may be a next generation system of the 5G system. Among them, the access network in the 5G system may be referred to as an NG-RAN (New Generation-Radio Access Network, or an MTC system.

Among them, the base station 12 may be an evolved base station (eNB) adopted in a 4G system. Alternatively, the base station 12 may also be a base station (gNB) adopting a centralized distributed architecture in a 5G system. When the base station 12 adopts a centralized distributed architecture, the base station 12 generally includes a central unit (CU) and at least two distributed units (DU). A protocol stack of a packet data convergence protocol (PDCP) layer, a radio link control protocol (RLC) layer, and a media access control (MAC) layer is provided in the centralized unit. A protocol stack of a physical (PHY) layer is provided in the distribution unit. The specific implementation manner of the base station 12 is not limited in the embodiments of the present disclosure.

A wireless connection may be established between the base station 12 and the UE 11 through the wireless air interface. In different embodiments, the wireless air interface is a wireless air interface based on a 4th generation mobile communication network technology (4G) standard. Alternatively, the wireless air interface is a wireless air interface based on a 5th generation mobile communication network technology (5G) standard, for example, the wireless air interface is a new radio. Alternatively, the wireless air interface may also be a wireless air interface based on a next generation mobile communication network technology standard of 5G.

In some embodiments, an E2E (end to end) connection may also be established between the UEs 11, such as scenes of V2V (Vehicle to Vehicle) communication, V21 (Vehicle to Infrastructure) communication and V2P (Vehicle to pedestrian) communication in vehicle to everything (V2X) communication.

In some embodiments, the wireless communication system may further include a network management device 13.

Several base stations 12 are respectively connected to the network management device 13. Among them, the network management device 13 may be a core network device in a wireless communication system. For example, the network management device 13 may be a mobility management entity (MME) in an evolved packet core (EPC). Alternatively, the network management device may be another core network device, such as a serving gateway (SGW), a public data network gateway (PGW), a policy and charging rules function (PCRF), or a home subscriber server (HSS), etc. For the implementation form of the network management device 13, the embodiments of the present disclosure do not limit.

For SL transmission using the NR cell as a synchronization reference source, it is specified that the SL transmission should be transmitted in advance by (N_{TA SL}+N_{TA offset})×T_{c} relative to the NR authorized frequency band downlink reception signal. In the related art, both N_{TA,SL} and N_{TAoffset} and are set to 0. T_{c} is a basic time unit in the NR system. For example, the value of T_{c} may be equal to 1/(480*1000*4096) seconds. N_{TA,SL} is an initial value of the time advance determined according to the terminal and the base station in the SL. N_{TA offset} is a fixed compensation value for calculating the time advance. The calculation result of (N_{TA,SL}+N_{TA offset})×T_{c} is the final time advance of the terminal. That is, after receiving the downlink signal of the authorized spectrum, the terminal immediately transmits the SL signal. In this case, the SL transmission of the terminal is aligned with the DL reception the terminal in time. However, due to the mechanism of time advance (TA), for the service of the authorized spectrum of the terminal itself, its UL transmission is to be received ahead of the DL reception, so as to ensure that the uplink subframes of a plurality of terminals are aligned in time when the plurality of terminals arrive at the base station after passing through different paths.

In this case, if the terminal is to perform NR transmission and SL transmission simultaneously, the SL transmission and the DL reception as well as the SL reception and the UL transmission may overlap in time. This overlap can cause serious in-band interference, so that the terminal cannot transmit the service of the SL simultaneously in the authorized frequency band, thereby reducing the utilization efficiency of the spectrum. In view of this, the embodiments of the present disclosure provide a technical solution for reducing in-band interference as much as possible and improving the effective utilization rate of communication resources as much as possible.

As shown in FIG. 2, an embodiment of the present disclosure provides a method for information processing, applied to a base station. The method includes the following.

In S110, according to a synchronous transmission capability of a terminal for a first wireless transmission mode and a second wireless transmission mode, a resource alignment mode in a time domain for a first wireless resource and a second wireless resource configured for the terminal is determined.

The method provided in the embodiment of the present disclosure may be applied to various base stations on a network side, for example, an evolved base station (eNB) or a next-generation base station (eNB), etc.

In some embodiments, the first wireless transmission mode and the second wireless transmission mode may be transmission modes sharing the frequency band. For example, in 5G, the NR authorized spectrum used by NR transmission and the NR SL frequency band used by the SL transmission are the same frequency band. That is, in the case that the NR transmission and the SL transmission share the frequency band, if the cellular communication of the NR authorized spectrum and the SL transmission on the SL occur simultaneously, there may be in-band interference.

Different types of terminals have different anti-interference capabilities. The anti-interference capability of some terminals is strong, and even if the transmission of the first wireless transmission mode and the second wireless transmission mode occurs synchronously, the transmission corresponding to the two wireless transmission modes can be successfully implemented. However, the anti-interference capability of some terminals is weak, that is, when the transmission of the first wireless transmission mode and the second wireless transmission mode occurs synchronously, at least one wireless transmission mode in the two transmission modes may experience transmission failure due to strong in-band interference.

In some embodiments, the first wireless transmission mode and the second wireless transmission mode may also be cellular mobile communication mode and WiFi communication that share unauthorized spectrum, and are not limited to NR transmission and SL transmission. The first wireless resource is a wireless resource used in the first wireless transmission mode, and the second wireless resource is a wireless resource used in the second wireless transmission mode.

Taking NR transmission and SL transmission as an example, if the anti-interference capability for same frequency of the terminal is strong, even if cellular communication and SL transmission of an NR authorized spectrum occur synchronously, SL transmission and cellular communication can also be successfully implemented. However, the anti-interference capability of some terminals is weak, that is, when the cellular communication and the SL transmission of the NR authorized spectrum occur synchronously, at least one of the SL transmission and the cellular communication may experience transmission failure due to strong in-band interference.

Therefore, in the embodiments of the present disclosure, the base station determines the resource alignment mode of the terminal according to the synchronous transmission capability of the terminal on the NR authorized spectrum and the NR SL.

The resource alignment mode of the terminal is an alignment mode in the time domain for the first wireless resource transmitted using the first wireless transmission mode and the second wireless resource transmitted using the second wireless transmission mode.

Taking the first wireless transmission mode and the second wireless transmission mode being NR transmission and SL transmission respectively as an example, the resource alignment mode of the terminal is the alignment mode in the time domain for the NR resource of the NR authorized spectrum and the SL resource of the NR SL.

The first wireless resource may include a second sub-resource for uplink transmission and/or a first sub-resource for downlink. The second wireless resource may be used for SL transmission and/or SL reception of the terminal.

For example, the resource alignment mode in the time domain for the transmission resource of the terminal is determined according to the synchronous transmission capability of the terminal on the new radio (NR) authorized spectrum and the NR sidelink (SL).

In some embodiments, if the resource alignment modes are different, the involved alignment resources are different.

For example, the resource alignment mode of the terminal includes that:
a first sub-resource of the first wireless resource is aligned with the second wireless resource in the time domain; and/or,
a second sub-resource of the first wireless resource is aligned with the second wireless resource in the time domain.

If the first wireless transmission mode is NR transmission, the first wireless resource used for the first wireless transmission mode may be divided into an uplink UL resource and a downlink DL resource. If the second transmission mode is SL transmission, in some embodiments, the resource alignment mode of the terminal may include that the UL resource of the NR resource is aligned with the SL resource in the time domain, and/or the DL resource of the NR resource is aligned with the SL resource in the time domain.

The UL resource may be used for a terminal to transmit an uplink service and/or an uplink signaling.

The DL resource may be used for a terminal to transmit a downlink service and/or downlink signaling.

The SL resource is used to transmit data and/or receive data on the SL.

It can be seen that the resource alignment mode of the terminal includes that the SL resource is aligned with the UL resource, and/or the SL resource is aligned with the DL resource.

For communication on the NR authorized spectrum, the UL resource has a time advance (TA) in the time domain relative to the DL resource. By setting the TA, terminals located at different positions in a cell can be aligned on the time of the uplink subframe when the signals transmitted through different uplink paths reach the base station, so that the base station can simultaneously receive the uplink signals of the plurality of terminals within a fixed time.

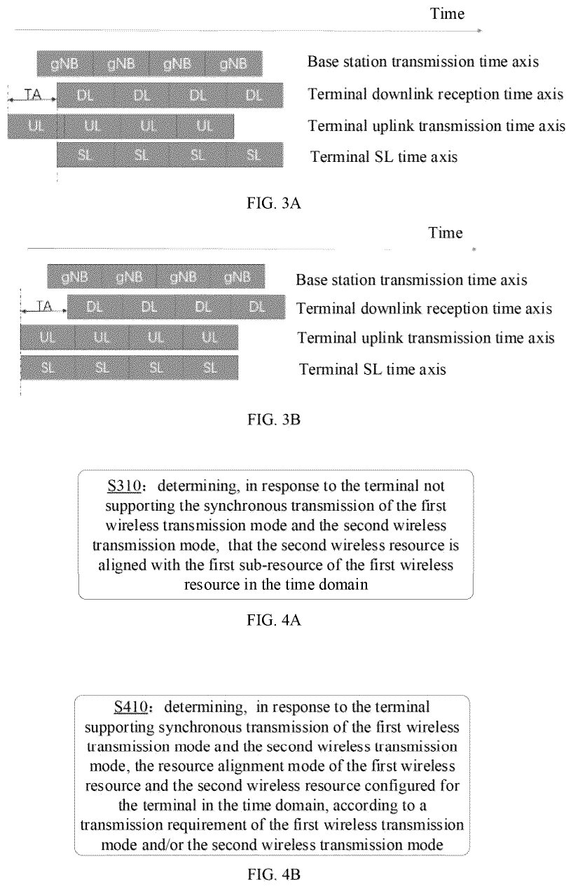

FIG. 3A is a schematic effect diagram of that a terminal SL time axis is aligned with a terminal downlink reception time axis on a time axis. The SL time axis is aligned with the terminal downlink reception time axis, that is, positions of SL resource and DL resource in the time domain are aligned. The SL time axis is aligned with the e terminal uplink transmission time axis, that is, resources of the SL resource and the UL resource in the time domain are aligned.

For example, the SL resource is aligned with the UL resource, which may include that an SL slot is aligned with a UL slot. The SL resource is aligned with the DL resource, which may include an SL slot is aligned with a DL slot.

FIG. 3B is a schematic effect diagram of that a terminal SL time axis is aligned with a terminal uplink transmission time axis on a time axis.

If the resource unit shown in FIG. 3A and FIG. 3B is a slot, and if the SL resource and the UL resource are aligned in the time domain, the SL slot and the UL slot allocated to one terminal are aligned in the time domain; and if the SL resource and the DL resource are aligned in the time domain, the SL slot and the DL slot allocated to one terminal are aligned in the time domain.

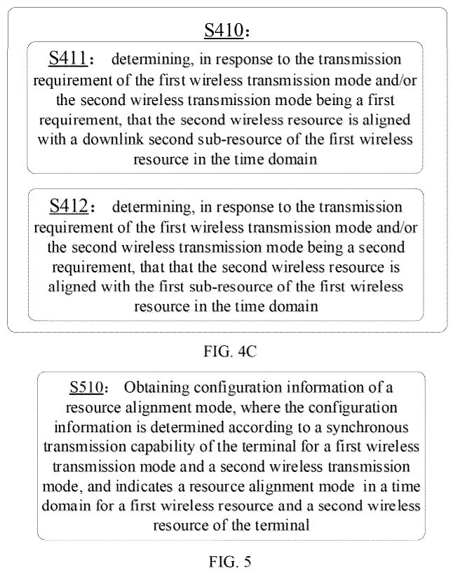

As shown in FIG. 4A, embodiments of the present disclosure provide a method for information processing, applied to a base station, and the method for information processing may include the following.

In S310, in response to the terminal not supporting the synchronous transmission of the first wireless transmission mode and the second wireless transmission mode, it is determined that the second wireless resource is aligned with the first sub-resource of the first wireless resource in the time domain.

In the embodiment of the present disclosure, the first sub-resource and the second sub-resource of a same terminal are not aligned in the time domain. Generally, the starting position of the first sub-resource in the time domain is later than the starting position of the second sub-resource. Taking the first wireless resource being an NR resource as an example, the first sub-resource is a DL resource, and the second sub-resource is a UL resource. The UL resource has an advance TA relative to the DL resource.

In some embodiments, the first sub-resource and the second sub-resource are both time-domain resources, and the unit of the time-domain resource may be a subframe, a slot, a mini-slot, a symbol, etc.

If the first sub-resource is a DL resource and the second sub-resource is a UL resource, the DL resource and the UL resource may be configured with a slot as a time domain resource unit.

Taking the first wireless transmission mode and the second wireless transmission mode being NR transmission and SL transmission respectively as an example, since the terminal does not support the synchronous transmission of NR transmission and SL transmission, that is, the terminal does not have the synchronous transmission capability of performing NR transmission on the NR authorized spectrum and simultaneously performing SL transmission on the NR SL, it is determined that the SL resource of the NR SL is aligned with the DL resource on the NR authorized spectrum in the time domain.

Since the first wireless resource has the characteristics that the second sub-resource is in advance relative to the first sub-resource in the time domain, if the second wireless resource is configured to be aligned with the first sub-resource in the time domain, the resource conflict between the second wireless resource and the first wireless resource can be reduced, so that the mitigation of a resource conflict and the mitigation of in-band interference are realized through this resource alignment mode.

In some embodiments, transmission on NR authorized spectrum and transmission of NR SR in the same authorized frequency band are used. Considering the synchronization requirements of the transmission on NR authorized spectrum and the transmission of NR SR, the terminal can immediately enter SL transmission after receiving the DL signal. In this case, SL transmission on the SL resource and DL reception are aligned in the time domain, which also satisfy the transmission requirement and the transmission inertia between DL transmission and SL transmission in the related art.

Embodiments of the present disclosure provide a method for information processing, applied to a base station, and the method for information processing may include the following.

In response to the terminal supporting the synchronous transmission of the first wireless transmission mode and the second wireless transmission mode, it is determined that the second wireless resource is aligned with the second sub-resource of the first wireless resource in the time domain.

In the embodiment, the terminal supports synchronous transmission of the first wireless transmission mode and the second wireless transmission mode, that is, the terminal has the synchronous transmission capability of simultaneously performing the first wireless transmission mode and the second wireless transmission mode, and it can be directly determined that the second wireless resource and the second sub-resource are aligned in the time domain.

For example, the terminal supports synchronous transmission on the NR authorized spectrum and the NR SL, that is, the terminal has a synchronous transmission capability of simultaneously performing SL transmission and transmission on the NR authorized spectrum, and it may be directly determined that the SL resource of the NR SL and the UL resource of the NR authorized spectrum are aligned.

As shown in FIG. 4B, embodiments of the present disclosure provide a method for information processing, applied to a base station, and the method for information processing may include the following.

In S410, in response to the terminal supporting synchronous transmission of the first wireless transmission mode and the second wireless transmission mode, the resource alignment mode in the time domain for the first wireless resource and the second wireless resource configured for the terminal is determined according to a transmission requirement of the first wireless transmission mode and/or the second wireless transmission mode.

In some embodiments, as shown in FIG. 4C, S410 may include the following.

In S411, in response to the transmission requirement of the first wireless transmission mode and/or the second wireless transmission mode being a first requirement, it is determined that the second wireless resource is aligned with a downlink second sub-resource of the first wireless resource in the time domain; and/or,

In S412, in response to the transmission requirement of the first wireless transmission mode and/or the second wireless transmission mode being a second requirement, it is determined that that the second wireless resource is aligned with the first sub-resource of the first wireless resource in the time domain.

There is a plurality of transmission requirements. For example, based on the high utilization requirement of the frequency band, the second wireless resource and the second sub-resource may be aligned in the time domain; for another example, based on the high transmission quality requirement, the second wireless resource and the first sub-resource may be aligned in the time domain.

In some other embodiments, S410 may further include the following.

In response to the terminal supporting synchronous transmission of the first wireless transmission mode and the second wireless transmission, it is determined to adopt that the second wireless resource is aligned with the second sub-resource or the second wireless resource is aligned with the first sub-resource, according to the frequency band shared by the first wireless transmission mode and the second wireless transmission mode.

For example, if the bandwidth of the frequency band shared by the first wireless transmission mode and the second wireless transmission mode is greater than a first preset value, it is determined to adopt that the second wireless resource and the second sub-resource are aligned; and if the bandwidth of the frequency band shared by the first wireless transmission mode and the second wireless transmission mode is smaller than or equal to the first preset value, it is determined to adopt that the second wireless resource and the first sub-resource are aligned.

For example, it is assumed that if the frequency band shared by the first wireless transmission mode and the second wireless transmission mode is a frequency band such as N79 with a large bandwidth, for the requirement of improving the effective utilization rate of the resource, it may be adopted that the second wireless resource and the second sub-resource are aligned.

For example, if the current load rate of the cell is relatively higher, the transmission requirement has a large capacity requirement, and at this time, for the terminal supporting synchronous transmission on the NR authorized spectrum and the NR second wireless resource, a resource alignment mode of the second wireless resource being aligned with the second sub-resource is adopted, otherwise, a resource alignment mode of the second wireless resource being aligned with the first sub-resource may be adopted.

In some embodiments, the method further includes the following.

Capability information indicating the synchronous transmission capability is received.

The terminal may report, to a base station, the capability information whether the terminal supports synchronous transmission of the first wireless transmission mode and the second wireless transmission mode. For example, one or more bits are carried in a capability field of the terminal to indicate whether the terminal supports synchronous transmission of the first wireless transmission mode and the second wireless transmission mode.

For example, the terminal may report, to a base station, the capability information whether the terminal supports synchronous transmission on the NR authorized spectrum and the NR SL. For example, one or more bits are carried in a capability field of the terminal to indicate whether the terminal supports synchronous transmission on the NR authorized spectrum and the NR SL.

In some embodiments, the terminal may report the capability information through Radio Resource Control (RRC) signaling.

In some embodiments, the method further includes the following.

Configuration information of the resource alignment mode of the terminal is issued.

The configuration information indicates a resource alignment mode configured by the base station according to the synchronous transmission capability whether the terminal supports synchronous transmission on the NR authorized spectrum and the NR SL.

For example, the configuration information may include one or more bits, and indicate the resource alignment mode. It is assumed that the alignment mode between the second wireless resource and the second sub-resource is the first alignment mode, the alignment mode between the second wireless resource and the first sub-resource is the second alignment mode. The configuration information may include at least one bit, and different bit values of the at least one bit indicate the first alignment mode and the second alignment mode respectively.

The foregoing is an example of the configuration information, and the specific implementation is not limited to this.

The configuration information of the resource alignment mode includes:
a first TA value of a second sub-resource of the first wireless resource of the terminal relative to a first sub-resource;
a second TA value of the second wireless resource of the terminal relative to the first sub-resource of the first wireless resource.

For example, it may be a first TA value of the UL resource of the terminal on the NR authorized spectrum relative to the DL resource.

It may be a second TA value of the SL resource of the terminal on the NR SL relative to the DL resource on the NR authorized spectrum.

In some embodiments, the base station may issue a TA value. In the embodiments of the present disclosure, since the NR authorized spectrum and the NR SL share a spectrum, there is a TA value (i.e., a first TA value) between the second sub-resource and the first sub-resource, and a TA value (i.e., the second TA value) between the second wireless resource and the first sub-resource.

In some embodiments, in response to the resource alignment mode of the terminal being that the second wireless resource is aligned with the first sub-resource in the time domain, the second TA value is 0; and/or, in response to the resource alignment mode of the terminal being that the second wireless resource is aligned with the second sub-resource in the time domain, the second TA value is equal to the first TA value.

The first TA value and the second TA value proposed in the related art are used to indicate the resource alignment mode of the terminal, without introducing a new dedicated field or dedicated information, which has the characteristic of strong compatibility with the related art. If the configuration information is issued to the terminal by the base station, the signaling overhead of the base station to indicate the configuration information of the resource alignment mode of the terminal will not be increased.

As shown in FIG. 5, embodiments of the present disclosure provide a method for information processing, applied to a terminal, and the method includes the following.

In S510, configuration information of a resource alignment mode is obtained, where the configuration information is determined according to a synchronous transmission capability of the terminal for a first wireless transmission mode and a second wireless transmission mode, and indicates a resource alignment mode in a time domain for a first wireless resource and a second wireless resource of the terminal.

For example, the configuration information of the resource alignment mode is obtained, where the configuration information is determined according to the synchronous transmission capability of the terminal on the new radio (NR) authorized spectrum and the NR sidelink (SL), and indicates the resource alignment mode in the time domain for a NR resource and a SL resource of the terminal. That is, the first wireless transmission mode and the second wireless transmission mode may be NR transmission and SL transmission, respectively. The first wireless resource for NR transmission is an NR resource, and the second wireless resource for SL transmission is an SL resource.

In some embodiments, the first wireless transmission mode is NR transmission, and the second transmission mode is SL transmission; and/or, the first sub-resource of the first wireless resource is a DL resource, and the second sub-resource of the first wireless resource may be a UL resource.

The method for information processing provided in the embodiments of the present disclosure may be applied to various terminals. Obtaining configuration information of the resource alignment mode here includes, but is not limited to, at least one of the following: configuration information of the resource alignment mode is received from a base station; configuration information of the resource alignment mode is determined according to a communication protocol; and/or configuration information of the resource alignment mode is received from another terminal of the same type as the terminal in the same cell.

The foregoing is merely examples of obtaining the configuration information, and there are various specific implementation manners, not limited to any one of the foregoing.

It should be noted that, no matter which manner is adopted to obtain the configuration information of the resource alignment mode of the terminal, the configuration information is determined according to whether the terminal supports the synchronous transmission capability on the NR authorized spectrum and the NR SL simultaneously.

In the embodiments of the present disclosure, the resource alignment mode at least includes a resource alignment mode in the time domain.

In some embodiments, there are a plurality of resource alignment modes indicated by the configuration information, at least including that the second sub-resource of the first wireless resource and the second wireless resource are aligned in the time domain.

In some embodiments, the configuration information indicates that the first sub-resource of the first wireless resource and the second wireless resource are aligned in the time domain, where the first sub-resource of the first wireless resource and the second wireless resource being aligned in the time domain, corresponds to that the terminal does not support synchronous transmission of the first wireless transmission mode and the second wireless transmission mode.

For example, if the terminal does not support that the NR transmission on the NR authorized spectrum and the SL transmission on the NR SL are synchronously performed, that is, the terminal does not support the synchronous transmission of the first wireless transmission mode and the second wireless transmission mode, at this time, the resource alignment mode of the terminal is that the second wireless resource and the first sub-resource are aligned in the time domain. Then, since the first sub-resource is later than the second sub-resource in the time domain, the conflict period between the second wireless resource and the first wireless resource can be reduced as much as possible, and the in-band interference is reduced.

In some embodiments, the configuration information indicates that a second sub-resource of the first wireless resource and the second wireless resource are aligned in the time domain, where the second sub-resource of the first wireless resource and the second wireless resource being aligned in the time domain, corresponds to that the terminal supports synchronous transmission of the first wireless transmission mode and the second wireless transmission mode.

For example, since the terminal supports performing NR transmission and SL transmission simultaneously, at this time, in order to improve the effective utilization rate of the communication resource, the second sub-resource and the second wireless resource can be directly aligned in the time domain. Thus, the second wireless resource is also configured within the TA value of the second sub-resource relative to the first sub-resource, and this period of time-domain resource can also be used for SL transmission, which improves the effective utilization rate of the resource. Meanwhile, since the second wireless resource is also configured within the TA value of the second sub-resource relative to the first sub-resource, SL transmission can be performed when the terminal has an SL transmission requirement during this period of time, which also improves the response rate for SL transmission.

However, considering to reduce the decoding difficulty of the terminal when performing SL transmission and UL transmission simultaneously, it may also be determined, according to the transmission requirement, whether the resource alignment mode of the terminal needs to be that the second wireless resource and the second sub-resource are aligned in the time domain.

For example, the second sub-resource of the NR resource and the second wireless resource are aligned in a time domain, where the second sub-resource of the NR resource and the second wireless resource being aligned in a time domain, corresponds to that the terminal supports synchronous transmission of the first wireless transmission mode and the second wireless transmission mode, and the transmission requirement of the first wireless transmission mode and/or the second wireless transmission mode is the first requirement.

Alternatively, the first sub-resource of the first wireless resource and the second wireless resource are aligned in a time domain, where the first sub-resource of the first wireless resource and the second wireless resource are aligned in the time domain, corresponds to that the terminal supports synchronous transmission of the first wireless transmission mode and the second wireless transmission mode, and the transmission requirement of the first wireless transmission mode and/or the second wireless transmission mode is the second requirement.

The first requirement is different from the second requirement.

For example, the communication resource usage rate requirement of the first requirement is higher than the resource usage rate requirement of the second requirement.

For another example, the communication capacity requirement of the first requirement is greater than the communication capacity requirement corresponding to the second requirement.

For another example, the response delay requirement for SL transmission of the first requirement is higher than the response delay requirement for SL transmission of the second requirement, where the higher the response delay requirement, the smaller the response delay for SL transmission is required.

In some embodiments, the method further includes the following. In response to the terminal not supporting synchronous transmission of the first wireless transmission mode and the second wireless transmission mode and having transmission requirements for both the first wireless transmission mode and the second wireless transmission mode, a transmission with a higher priority in the first wireless transmission mode and the second wireless transmission mode is transmitted at a time domain position where the first wireless resource and the second wireless resource are configured simultaneously, according to priorities of the first wireless transmission mode and the second wireless transmission mode.

NR transmission herein includes UL transmission and/or DL transmission of the first wireless resource. The first wireless resource here includes a second sub-resource and/or a first sub-resource of the first wireless resource.

If the terminal does not support synchronous transmission on the NR authorized spectrum and the NR SL, in order to reduce in-band interference, and the terminal currently has transmission requirements both for the first wireless transmission mode and the second wireless transmission mode, according to the priorities of SL transmission and NR transmission, NR transmission or SL transmission with a higher priority is performed at the time domain position where the first wireless resource and the second wireless resource are configured simultaneously.

The priorities of SL transmission and NR transmission here may be based on the service priorities of NR transmission and SL transmission, but are not limited to service priorities. For example, a service priority of an ultra-reliable low-latency communication (URLLC) service is higher than a service priority of an enhanced mobile broadband (eMBB) service.

In some other embodiments, if both the NR transmission and the SL transmission are mapped to logical channels, the priority here may also be determined by the priority of the logical channel.

In summary, in the embodiments of the present disclosure, if there is a need to perform NR transmission and SL transmission simultaneously on the second wireless resource and the first wireless resource that conflict on the time domain, in order to reduce in-band interference, NR transmission or SL transmission of a higher priority with a higher emergency degree can be transmitted preferentially according to the priorities, thus ensuring that NR transmission or SL transmission of a higher priority with lower delay tolerance is performed preferentially.

In some embodiments, the configuration information includes a first TA value indicating a time advance of the second sub-resource of the first wireless resource relative to the first sub-resource, and a second TA value indicating a timing advance of the second wireless resource relative to the first sub-resource.

The first TA value and the second TA value can collectively reflect the resource alignment mode of the terminal.

In some embodiments, the second TA value is 0, which indicates that the resource alignment mode of the terminal is that the second wireless resource is aligned with the first sub-resource in the time domain; or, the second TA value is equal to the first TA value, which indicates that the resource alignment mode of the terminal is that the second wireless resource is aligned with the second sub-resource of the NR resource in the time domain.

In the embodiment, if the first TA value is equal to the second TA value, it indicates that the current resource alignment mode of the terminal is that the second wireless resource is aligned with the second sub-resource; and, if the second TA value is 0, it indicates that the current resource alignment mode of the terminal is that the second wireless resource is aligned with the first sub-resource.

In another embodiment, the second TA value may have only one bit, and different bit values of the one bit are used to indicate whether the second TA value is consistent with the first TA value. For example, the second TA value is 0, indicating that the second TA value is inconsistent with the first TA value and the second TA value is 0. The second TA value is 1, indicating that the second TA value is consistent with the first TA value. In this way, the second TA value has the characteristic of low bit overhead.

The first TA value and the second TA value proposed in the related art are used to indicate the resource alignment mode of the terminal, without introducing a new dedicated field or dedicated information, which has the characteristic of strong compatibility with the related art. If the configuration information is issued to the terminal by the base station, the signaling overhead of the base station to indicate the configuration information of the resource alignment mode of the terminal will not be increased.

Embodiments of the present disclosure provide a method for information processing, including that:

in response to the UE not supporting performing NR transmission and SL transmission simultaneously, the DL resource for the UE is aligned with the SL resource in the time domain.

Embodiments of the present disclosure provide a method for information processing, including that, in response to the UE supporting simultaneous NR transmission and SL transmission and having a requirement for synchronous NR transmission and SL transmission, the UL resource for the UE is aligned with the SL resource in the time domain.

Embodiments of the present disclosure provide a method for information processing, including that, in response to the UE supporting simultaneous NR transmission and SL transmission and having no requirement for synchronous NR transmission and SL transmission, the DL resource for the UE is aligned with the SL resource in the time domain.

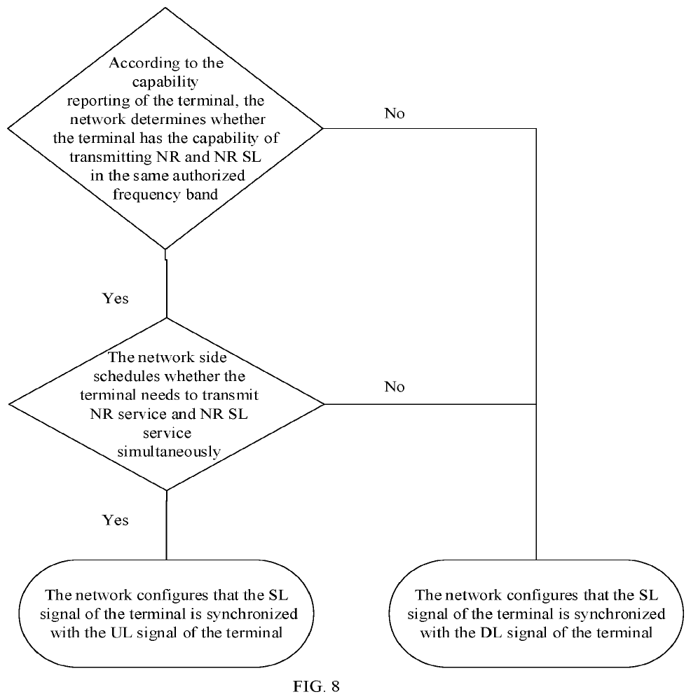

For example, referring to FIG. 8, the network determines whether the terminal supports simultaneous NR transmission and SL transmission according to the capability reporting of the terminal (i.e., the UE).

In some embodiments, in response to the UE not supporting simultaneous NR transmission and SL transmission, the SL signal of the UE is configured to be synchronized with the DL signal of the terminal. The SL signal and the DL signal are synchronized, indicating that the transmission resource for the SL signal (i.e., the SL resource) and the resource for transmitting the DL signal (DL resource) are synchronized (or referred to be aligned).

In some embodiments, in response to the UE supporting simultaneous NR transmission and SL transmission and needing to transmit the NR service and the SL service simultaneously, the SL signal of the UE is configured to be synchronized with the UL signal of the terminal. The SL signal and the UL signal are synchronized, indicating that the transmission resource for the SL signal (i.e., the SL resource) and the resource for transmitting the UL signal (i.e., the UL resource) are synchronized (or referred to be aligned).

In some embodiments, in response to the UE supporting simultaneous NR transmission and SL transmission and not needing to transmit the NR service and the SL service simultaneously, the SL signal of the UE is configured to be synchronized with the DL signal of the terminal. The SL signal and the DL signal are synchronized, indicating that the transmission resource for the SL signal (i.e., the SL resource) and the resource for transmitting the DL signal (DL resource) are synchronized (or referred to be aligned).

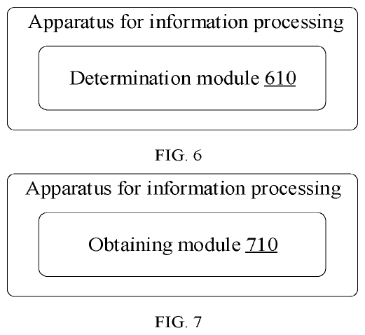

As shown in FIG. 6, embodiments of the present disclosure provide an apparatus for information processing, applied to a base station. The apparatus includes a determination module 610.

The determination module 610 is configured to determine, according to a synchronous transmission capability of a terminal for a first wireless transmission mode and a second wireless transmission mode, a resource alignment mode in a time domain for a first wireless resource and a second wireless resource configured for the terminal.

In some embodiments, the determination module 610 may be a program module. After the program module is executed by a processor, the resource alignment mode of the terminal can be determined according to whether the terminal has a synchronous transmission capability on the NR authorized spectrum and the NR SL.

In another embodiment, the determination module 610 may include a soft-hard combination module. The soft-hard combination module includes, but is not limited to, a programmable array; and the programmable array includes, but is not limited to, a field programmable array and/or a complex programmable array.

In yet another embodiment, the determination module 610 may include a pure hardware module; and the pure hardware module includes, but is not limited to, an application specific integrated circuit.

In some embodiments, a first sub-resource of the first wireless resource and the second wireless resource are aligned in the time domain, and/or, a second sub-resource of the first wireless resource and the second wireless resource are aligned in the time domain.

In some embodiments, the resource alignment mode of the terminal includes that:
a first sub-resource of the first wireless resource and the second wireless resource are aligned in the time domain; and/or, a second sub-resource of the first wireless resource and the second wireless resource are aligned in the time domain.

In some embodiments, the determination module 610 is configured to determine, in response to the terminal not supporting synchronous transmission in the first wireless transmission mode and the second wireless transmission mode, that the second wireless resource is aligned with a first sub-resource of the first wireless resource in the time domain.

In some embodiments, the determination module 610 is configured to determining, in response to the terminal supporting synchronous transmission of the first wireless transmission mode and the second wireless transmission mode, the resource alignment mode in the time domain for the first wireless resource and the second wireless resource configured for the terminal, according to a transmission requirement of the first wireless transmission mode and/or the second wireless transmission mode.

In some embodiments, the determination module 610 is configured to: determine, in response to the transmission requirement of the first wireless transmission mode and/or the second wireless transmission mode being a first requirement, that the second wireless resource is aligned with a downlink second sub-resource of the first wireless resource in a time domain; or, determine, in response to the transmission requirement of the first wireless transmission mode and/or the second wireless transmission mode being a second requirement, that the second wireless resource is aligned with a first sub-resource of the first wireless resource in the time domain.

In some embodiments, the apparatus further includes a reception module.

The reception module is configured to receive capability information indicating the synchronous transmission capability.

In some embodiments, the configuration information of the resource alignment mode includes a first time advance (TA) value of a second sub-resource of the first wireless resource of the terminal relative to a first sub-resource, and second TA value of the second wireless resource of the terminal relative to the first sub-resource of the first wireless resource.

In some embodiments, in response to the resource alignment mode of the terminal being that the second wireless resource is aligned with the first sub-resource in the time domain, the second TA value is 0.

Alternatively, in response to the resource alignment mode of the terminal being that the second wireless resource is aligned with the second sub-resource in the time domain, and the second TA value is equal to the first TA value.

As shown in FIG. 7, embodiments of the present disclosure provide an apparatus for information processing, applied to a terminal. The apparatus includes an obtaining module 710.

The obtaining module 710 is configured to obtain configuration information of a resource alignment mode, where the configuration information is determined according to a synchronous transmission capability of the terminal for a first wireless transmission mode and a second wireless transmission mode, and indicates a resource alignment mode in a time domain for the first wireless resource and the second wireless resource of the terminal.

In some embodiments, the obtaining module 710 may be a program module. After the program module is executed by a processor, configuration information of a resource alignment mode determined according to whether the terminal has the synchronous transmission capability for performing synchronous transmission on the NR authorized spectrum and the NR SL may be obtained.

In another embodiment, the obtaining module 710 may include a soft-hard combination module. The soft-hard combination module includes, but is not limited to, a programmable array; and the programmable army includes, but is not limited to, a field programmable array and/or a complex programmable array.

In yet another embodiment, the obtaining module 710 may include a pure hardware module, and the pure hardware module includes, but is not limited to, an application specific integrated circuit.

In some embodiments, the first wireless transmission mode is NR transmission on a new radio (NR) authorized spectrum, and the second wireless transmission mode is SL transmission on an NR sidelink (SL).

In some embodiments, the configuration information indicates that a first sub-resource of the first wireless resource and the second wireless resource are aligned in the time domain; where the first sub-resource of the first wireless resource and the second wireless resource being aligned in the time domain, corresponds to that the terminal does not support synchronous transmission of the first wireless transmission mode and the second wireless transmission mode.

In some embodiments, the configuration information indicates that a second sub-resource of the first wireless resource and the second wireless resource are aligned in the time domain; where the second sub-resource of the first wireless resource and the second wireless resource being aligned in the time domain, corresponds to that the terminal supports synchronous transmission of the first wireless transmission mode and the second wireless transmission mode, and a transmission requirement of the first wireless transmission mode and/or the second wireless transmission mode is a first requirement, or a first sub-resource of the first wireless resource and the second wireless resource are aligned in the time domain; where the first sub-resource of the first wireless resource and the second wireless resource being aligned in the time domain, corresponds to that the terminal supports synchronous transmission of the first wireless transmission mode and the second wireless transmission mode, and the transmission requirement of the first wireless transmission mode and/or the second wireless transmission mode is a second requirement.

In some embodiments, the apparatus further includes a transmission module. The transmission module is configured to transmit, in response to the terminal not supporting synchronous transmission of the first wireless transmission mode and the second wireless transmission mode and having transmission requirements for both the first wireless transmission mode and the second wireless transmission mode, a transmission of a higher priority in the first wireless transmission mode and the second wireless transmission mode at a time domain position where the first wireless resource and the second wireless resource are configured simultaneously, according to priorities of the first wireless transmission mode and the second wireless transmission mode.

In some embodiments, the configuration information includes a first TA value indicating a time advance of a second sub-resource of the first wireless resource relative to the first sub-resource, and a second TA value indicating a timing advance of the second wireless resource relative to the first sub-resource.

In some embodiments, the second TA value is 0, indicating that the resource alignment mode of the terminal is that the second wireless resource is aligned with the first sub-resource in the time domain.

Alternatively, the second TA value is equal to the first TA value, indicating that the resource alignment mode of the terminal is that the second wireless resource is aligned with the second sub-resource of the first wireless resource in the time domain.

For example, for transmitting the NR SL service in the authorized frequency band, there is temporal overlap between the SL transmission and the DL reception of the terminal as well as between the SL reception and the UL transmission, therefore causing serious in-band interference, resulting in that the terminal cannot simultaneously transmit the SL service in the authorized frequency band, thus reducing the utilization efficiency of the spectrum.

In embodiments of the present disclosure, in accordance with the problem that there is temporal overlap between the SL transmission and the DL reception of the terminal as well as between the SL reception and the UL transmission, which causes serious in-band interference, resulting in that the terminal cannot simultaneously transmit the SL service in the authorized frequency band, thus reducing the utilization efficiency of the spectrum, it is determined whether the terminal has the capability of simultaneous transmission of the NR authorized spectrum service and the NR SL service according to the capability reporting of the terminal, and it is determined subsequently whether the terminal needs to simultaneously transmit the NR authorized spectrum service and the NR SL service according to the scheduling of the network, so that different terminal resource alignment modes are used to cope with different transmission requirements.

For example, the terminal reports to the network according to its capability. If the terminal does not have the capability of simultaneously transmitting the NR service and the NR SL service in the same authorized spectrum, the SL slot of the terminal is aligned with the DL slot of the network received by the terminal. The service actually transmitted by the terminal is determined according to the priorities of the NR authorized spectrum service and the NR SL service. The terminal transmits the service with a higher priority.

The NR service is service data carried by NR transmission on the NR authorized spectrum. The NR SL service may be service data transmitted on the NR SL.

As shown in FIG. 8, embodiments of the present disclosure provide a method for information processing, which may include the following.

According to the capability reporting of the terminal, the network determines whether the terminal has the capability of transmitting NR and NR SL in the same authorized frequency band; the capability of transmitting NR and NR SL refers to perform NR transmission and SL transmission simultaneously.

If so, the network side schedules whether the terminal needs to transmit NR service and NR SL service simultaneously.

If so, the network configures that the SL signal of the terminal is synchronized with the UL signal of the terminal, that is, to configure that the SL resource is synchronized with the UL resource (“synchronized” here is also referred to as “aligned”).

If not, the network configures that the SL signal of the terminal is synchronized with the DL signal of the terminal, that is, to configure that the SL resource is synchronized with the DL resource (“synchronized” here is also referred to as “aligned).

For example, the terminal reports to the network, according to its capability, that it has the capability of simultaneously transmitting the NR service and the NR SL service on the same authorized frequency band. The network side schedules the terminal to perform simultaneous NR authorized spectrum service and NR SL service on the same authorized frequency band. The SL slot of the terminal is aligned with the UL slot set by the terminal. The terminal configures the corresponding SL transmission and reception according to the ratio of the uplink slot and the downlink slot, so that the terminal transmits the NR service and the NR SL service simultaneously on the same authorized frequency band.

Embodiments of the present disclosure provide a communication device, including a memory for storing processor-executable instructions and processors, respectively connected to the memory. The processor can be configured to execute the method for information processing provided by any of the foregoing technical solutions through executing computer-executable instructions stored on the memory.

The memory may include various types of storage medium. The storage medium is a non-transitory computer storage medium, and may continue to memorize the information stored on it after the communication device is powered down.

Here, the communication device includes a base station or a terminal. The terminal may also be referred to as a user equipment (UE).

The processor may be connected to the memory through a bus or the like, and configured to read an executable program stored on the memory, for example, at least one of the methods shown in FIG. 2, FIG. 4A to FIG. 4C, FIG. 5, and/or FIG. 8.

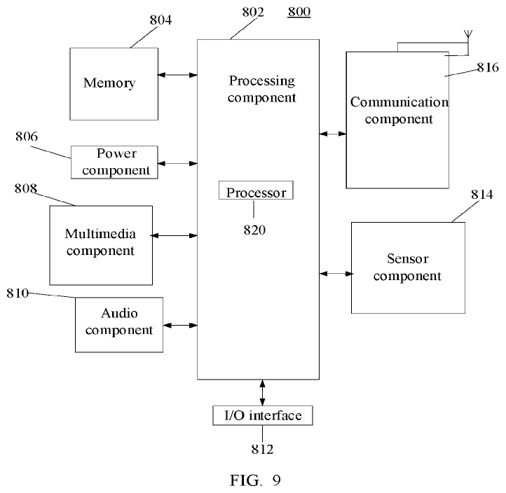

FIG. 9 is a block diagram of a UE (terminal) 800 according to some embodiments of the present disclosure. For example, the UE 800 may be a mobile phone, a computer, a digital broadcast user equipment, a message reception device, a game console, a tablet device, a medical device, an exercise device, a personal digital assistant, etc.

Referring to FIG. 9, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the UE 800, such as display, telephone calls, data communications, camera operations, and operations associated with recording operations. The processing component 802 may include one or more processors 820 for executing instructions to complete all or some of the steps of the foregoing methods. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of such data include instructions of any application or method for operating on the UE 800, contact data, phonebook data, messages, pictures, videos, and the like. The memory 804 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides electrical power to various components of the UE 800. The power component 806 may include a power management system, one or more power sources, and other components associated with generating, managing, and allocating power for the UE 800.

The multimedia component 808 includes a screen providing an output interface between the UE 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touches, sliding, and gestures on the touch panel. The touch sensor may not only sense a boundary of a touch or sliding action, but also detect a duration and pressure associated with the touch or sliding action. In some embodiments, the multimedia component 808 includes a front-facing camera and/or a rear-facing camera. When the UE 800 is in an operation mode, such as a photographing mode or a video mode, the front-facing camera and/or the rear-facing camera may receive external multimedia data. Each front-facing camera and rear-facing camera may be a fixed optical lens system or have a focal length and an optical zoom capability.

The audio component 810 is configured to output and/or input an audio signal. For example, the audio component 810 includes a microphone (MIC) configured to receive an external audio signal when the UE 800 is in an operating mode, such as a call mode, a recording mode, and a speech recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and the peripheral interface module, and the peripheral interface module may be a keyboard, a click wheel, a button, or the like. The button may include, but are not limited to, a home button, a volume button, a start button, and a lock button.

The sensor component 814 includes one or more sensors for providing status assessments of various aspects for the UE 800. For example, the sensor component 814 may detect the on/off state of the device 800, the relative positioning of the components, for example the components being the display and the keypad of the UE 800. The sensor component 814 may also detect the position change of the UE 800 or one component of the UE 800, the presence or absence of contact between the user and the UE 800, the orientation or acceleration/deceleration of the UE 800, and the temperature change of the UE 800. The sensor component 14 may include a proximity sensor configured to detect the presence of nearby objects without any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on any communication standard, such as WiFi, 2G, or 3G, or a combination of them. In some embodiments of the present disclosure, the communication component 816 receives broadcast signals or broadcast related information from an external broadcast management system via a broadcast channel. In one exemplary embodiment, the communication component 816 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments of the present disclosure, the UE 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic components for performing the methods described above.

In some embodiments of the present disclosure, there is further provided is a non-transitory computer-readable storage medium including instructions, for example, a memory 804 including instructions. The instruction may be executed by the processor 820 of the UE 800 to complete the foregoing method. For example, the non-transitory computer-readable storage medium may be a ROM, a random access memory (RAM), a CD-ROM, a magnetic tape, a floppy disk, an optical data storage device, etc.

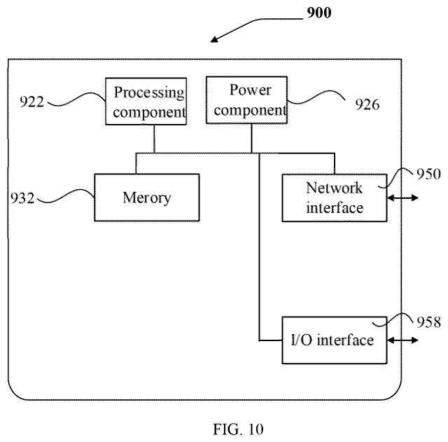

As shown in FIG. 10, it illustrates a structure of a base station according to embodiments of the present disclosure. For example, base station 900 may be provided as a network-side device. Referring to FIG. 10, the base station 900 includes the processing component 922, which further includes one or more processors, and memory resources represented by memory 932, for storing instructions executable by the processing component 922, such as applications. The application stored in the memory 932 may include one or more modules each corresponding to a set of instructions. In addition, the processing component 922 is configured to execute the instruction to perform any above-mentioned method applied to the base station, for example, a method as shown in FIG. 2, FIG. 4A, FIG. 4B. FIG. 4C, FIG. 5, and/or FIG. 8.

The base station 900 may also include a power component 926 configured to perform power management of the base station 900, a wired or wireless network interface 950 configured to connect the base station 900 to the network, and an input-output (I/O) interface 958. The base station 900 may operate an operating system stored in the memory 932, such as Windows Server™, Mac OS X™, Unix™, Linux™, FreeBSD™, or the like.

According to the technical solution provided in the embodiments of the present disclosure, the resource alignment mode in the time domain for the first wireless resource and the second wireless resource of the terminal can be determined according to the synchronous transmission capability of the terminal. On one hand, the possibly existing in-band interference can be reduced as much as possible through the resource configuration. On the other hand, the second wireless resource can be flexibly configured under the condition that the terminal has the capability of synchronously executing the first wireless transmission mode and the second wireless transmission mode, so that the configuration flexibility of the second wireless resource is improved while reducing the resource waste, that is, improving the effective utilization rate of the communication resource.

Other embodiments of the present disclosure will be apparent to those skilled in the art from consideration of the description and practice of the present disclosure disclosed here. The present disclosure is intended to cover any variations, uses, or adaptations of the present disclosure following the general principles of the present disclosure and including common general knowledge or conventional technical means in the art not disclosed in the present disclosure. The description and examples are considered as exemplary only, and the true scope and spirit of the present disclosure are indicated by the following claims.

It should be understood that the present disclosure is not limited to the precise structure that has been described above and illustrated in the accompanying drawings, and that various modifications and changes may be made without departing from the scope of the present disclosure. The scope of the present disclosure is limited only by the appended claims.

Obviously, numerous modifications and variations of the present invention are possible in light of the above teachings. It is therefore to be understood that within the scope of the appended claims, the invention may be practiced otherwise than as specifically described herein.

1. A method for information processing, comprising:
determining, by a base station, according to a synchronous transmission capability of a terminal for a first wireless transmission mode and a second wireless transmission mode, a resource alignment mode in a time domain for a first wireless resource and a second wireless resource configured for the terminal.

2. The method according to claim 1, wherein,
the first wireless transmission mode is NR transmission on a new radio (NR) authorized spectrum; and
the second wireless transmission mode is SL transmission on an NR sidelink (SL).

3. The method according to claim 1, wherein the resource alignment mode of the terminal comprises at least one of following:
a first sub-resource of the first wireless resource and the second wireless resource are aligned in the time domain;
or,
a second sub-resource of the first wireless resource and the second wireless resource are aligned in the time domain.

4. The method according to claim 1, wherein determining, according to a synchronous transmission capability of a terminal for a first wireless transmission mode and a second wireless transmission mode, a resource alignment mode in a time domain for a first wireless resource and a second wireless resource configured for the terminal comprises:
determining, in response to the terminal not supporting synchronous transmission of the first wireless transmission mode and the second wireless transmission mode, that the second wireless resource is aligned with a first sub-resource of the first wireless resource in the time domain.

5. The method according to claim 1, wherein determining, according to a synchronous transmission capability of a terminal for a first wireless transmission mode and a second wireless transmission mode, a resource alignment mode in a time domain for a first wireless resource and a second wireless resource configured for the terminal comprises:
determining, in response to the terminal supporting synchronous transmission of the first wireless transmission mode and the second wireless transmission mode, the resource alignment mode in the time domain for the first wireless resource and the second wireless resource configured for the terminal, according to a transmission requirement of the first wireless transmission mode and/or the second wireless transmission mode.

6. The method according to claim 5, wherein determining the resource alignment mode in the time domain for the first wireless resource and the second wireless resource configured for the terminal according to a transmission requirement of the first wireless transmission mode and/or the second wireless transmission mode comprises at least one of following:
determining, in response to the transmission requirement of the first wireless transmission mode and/or the second wireless transmission mode being a first requirement, that the second wireless resource is aligned with a downlink second sub-resource of the first wireless resource in the time domain; or,
determining, in response to the transmission requirement of the first wireless transmission mode and/or the second wireless transmission mode being a second requirement, that the second wireless resource is aligned with a first sub-resource of the first wireless resource in the time domain.

7. The method according to claim 1, further comprising:
receiving capability information indicating the synchronous transmission capability.

8. The method according to claim 7, wherein configuration information of the resource alignment mode comprises:
a first time advance (TA) value of a second sub-resource of the first wireless resource of the terminal relative to a first sub-resource; and
a second TA value of the second wireless resource of the terminal relative to the first sub-resource.

9. The method according to claim 8, wherein the second TA value comprises at least one of following:
in response to the resource alignment mode of the terminal being that the second wireless resource is aligned with the first sub-resource in the time domain, the second TA value is 0; or,
in response to the resource alignment mode of the terminal being that the second wireless resource is aligned with the second sub-resource in the time domain, the second TA value is equal to the first TA value.

10. The method according to claim 2, wherein the first sub-resource comprises a downlink (DL) resource, and the second sub-resource comprises an uplink (UL) resource.

11. A method for information processing comprising:
obtaining, by a terminal, configuration information of a resource alignment mode, wherein the configuration information is determined according to a synchronous transmission capability of the terminal for a first wireless transmission mode and a second wireless transmission mode, and indicates a resource alignment mode in a time domain for a first wireless resource and a second wireless resource of the terminal.

12. The method according to claim 11, wherein the configuration information indicates that:
a first sub-resource of the first wireless resource and the second wireless resource are aligned in the time domain; wherein the first sub-resource of the first wireless resource and the second wireless resource being aligned in the time domain, corresponds to that the terminal does not support synchronous transmission of the first wireless transmission mode and the second wireless transmission mode.

13. The method according to claim 12, wherein the configuration information indicates at least one of fallowing:
a second sub-resource of the first wireless resource and the second wireless resource are aligned in the time domain; wherein the second sub-resource of the first wireless resource being aligned with the second wireless resource in the time domain, corresponds to that the terminal supports synchronous transmission of the first wireless transmission mode and the second wireless transmission mode, and a transmission requirement of the first wireless transmission mode and/or the second wireless transmission mode is a first requirement; or,
a first sub-resource of the first wireless resource and the second wireless resource are aligned in the time domain; wherein the first sub-resource of the first wireless resource and the second wireless resource being aligned in the time domain, corresponds to that the terminal supports synchronous transmission of the first wireless transmission mode and the second wireless transmission mode, and the transmission requirement of the first wireless transmission mode and/or the second wireless transmission mode is a second requirement.

14. The method according to claim 12, wherein the method further comprises:
transmitting, in response to the terminal not supporting synchronous transmission of the first wireless transmission mode and the second wireless transmission mode and having transmission requirements for both the first wireless transmission mode and the second wireless transmission mode, a transmission of a higher priority in the first wireless transmission mode and the second wireless transmission mode at a time domain position where the first wireless resource and the second wireless resource are configured simultaneously, according to priorities of the first wireless transmission mode and the second wireless transmission mode.

15. The method according to claim 11, wherein the configuration information comprises:
a first TA value indicating a time advance of a second sub-resource of the first wireless resource relative to a first sub-resource; and
a second TA value indicating a time advance of the second wireless resource relative to the first sub-resource.

16. The method according to claim 15, wherein, the second TA value comprises at least one of following:
the second TA value is 0, indicating that the resource alignment mode of the terminal is that the second wireless resource is aligned with the first sub-resource in the time domain; or
the second TA value is equal to the first TA value, indicating that the resource alignment mode of the terminal is that the second wireless resource is aligned with the second sub-resource of the first wireless resource in the time domain.

17-20. (canceled)

21. A communication device, comprising a processor, a transceiver, a memory, and an executable program stored on the memory and capable of being run by the processor, wherein the processor executes a method for information processing when running the executable program, and the method comprises:
determining, according to a synchronous transmission capability of a terminal for a first wireless transmission mode and a second wireless transmission mode, a resource alignment mode in a time domain for a first wireless resource and a second wireless resource configured for the terminal.

22. A non-transitory computer storage medium, wherein the computer storage medium stores an executable program; after the executable program is executed by a processor, the method according to claim 1 is able to be implemented.

23. A communication device, comprising a processor, a transceiver, a memory, and an executable program stored on the memory and capable of being run by the processor, wherein the processor executes the method according to claim 11 when running the executable program.

24. A non-transitory computer storage medium, wherein the computer storage medium stores an executable program; after the executable program is executed by a processor, the method according to claim 11 is able to be implemented.
